(19) United States
(12) Patent Application Publication
(10) Pub. No.: US 2026/0271009 A1
(43) Pub. Date: Sep. 10, 2026

(54) TRANSMITTING AND RECEIVING ON DEMAND SIB1

(71) Applicant: Samsung Electronics Co., Ltd., Suwon-si (KR)

(72) Inventors: Anil Agiwal, McKinney, TX (US); Kyeongin Jeong, Frisco, TX (US); Hongbo Si, Allen, TX (US)

(21) Appl. No.: 19/543,525

(22) Filed: Feb. 18, 2026

Related U.S. Application Data
(60) Provisional application No. 63/767,867, filed on Mar. 6, 2025.

(51) Int. Cl. H04W 72/23; H04B 17/318; H04W 74/0833

(52) U.S. Cl. CPC H04W 72/23; H04B 17/328; H04W 74/0833

(57) ABSTRACT

A method of operating a user equipment (UE) includes determining a first determination whether the UE has received information indicating that a physical downlink control channel (PDCCH) for a system information block 1 (SIB1) in a SIB1 monitoring window is transmitted in a PDCCH monitoring occasion corresponding to a synchronization signal block (SSB) associated with a random access channel (RACH) preamble transmission for requesting a SIB1 of a cell. The method also includes, in response to the first determination being affirmative, monitoring, in the SIB1 monitoring window, the PDCCH monitoring occasion corresponding to the SSB associated with the RACH preamble transmission for requesting the SIB1 of the cell.

### CROSS-REFERENCE TO RELATED APPLICATION(S) AND CLAIM OF PRIORITY

This application claims priority under 35 U.S.C. § 119(e) to U.S. Provisional Patent Application No. 63/767,867 filed on Mar. 6, 2025. The above-identified provisional patent application is hereby incorporated by reference in its entirety.

### TECHNICAL FIELD

This disclosure relates generally to wireless networks. More specifically, this disclosure relates to transmitting and receiving on demand system information block 1 (SIB1).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for transmitting and receiving on demand SIB1.

In one embodiment, a method of operating a user equipment (UE) is provided. The method includes determining a first determination whether the UE has received information indicating that a physical downlink control channel (PDCCH) for a system information block 1 (SIB1) in a SIB1 monitoring window is transmitted in a PDCCH monitoring occasion corresponding to a synchronization signal block (SSB) associated with a random access channel (RACH) preamble transmission for requesting a SIB1 of a cell. The method also includes, in response to the first determination being affirmative, monitoring, in the SIB1 monitoring window, the PDCCH monitoring occasion corresponding to the SSB associated with the RACH preamble transmission for requesting the SIB1 of the cell.

In another embodiment, a method of operating a base station (BS) is provided. The method includes transmitting information indicating that a PDCCH for a SIB1 in a SIB1 monitoring window is transmitted in a PDCCH monitoring occasion corresponding to an SSB associated with a RACH preamble transmission for requesting a SIB1 of a cell. The method also includes transmitting the SIB 1 of the cell in the SIB1 monitoring window, in the PDCCH monitoring occasion corresponding to the SSB associated with the RACH preamble transmission for requesting the SIB1 of the cell.

In yet another embodiment, an electronic device is provided. The electronic device includes at least processor including processing circuitry, and memory storing instructions. The instructions, when executed by the at least one processor individually or collectively, cause the electronic device to determine a first determination whether the electronic device has received information indicating that a PDCCH for a SIB1 in a SIB1 monitoring window is transmitted in a PDCCH monitoring occasion corresponding to a synchronization signal block (SSB) associated with a random access channel (RACH) preamble transmission for requesting a SIB1 of a cell. The instructions, when executed by the at least one processor individually or collectively, further cause the electronic device to, in response to the first determination being affirmative, monitor, in the SIB1 monitoring window, the PDCCH monitoring occasion corresponding to the SSB associated with the RACH preamble transmission for requesting the SIB1 of the cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for transmitting and receiving SIB1 according to embodiments of the present disclosure;

FIG. 5 illustrates another example procedure for transmitting and receiving SIB1 according to embodiments of the present disclosure;

FIG. 6 illustrates another example procedure for transmitting and receiving SIB1 according to embodiments of the present disclosure;

FIG. 7 illustrates another example procedure for transmitting and receiving SIB1 according to embodiments of the present disclosure;

FIG. 8 illustrates another example procedure for transmitting and receiving SIB1 according to embodiments of the present disclosure;

FIG. 9 illustrates another example procedure for transmitting and receiving SIB1 according to embodiments of the present disclosure;

FIG. 10 illustrates an example method for transmitting and receiving SIB1 according to embodiments of the present disclosure; and

FIG. 11 illustrates another example method for transmitting and receiving SIB1 according to embodiments of the present disclosure.

### DETAILED DESCRIPTION

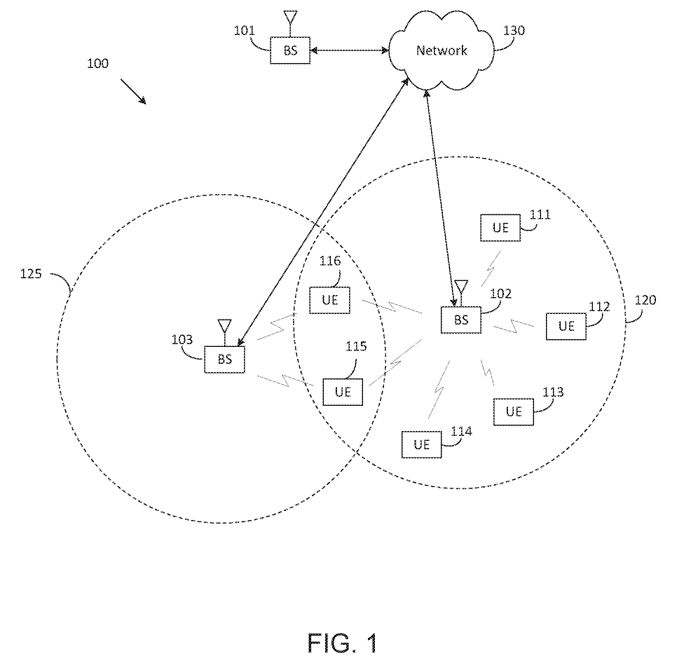

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving on demand SIB1. In certain embodiments, one or more of the gNBs 101-103 includes circuitry, programing, or a combination thereof, to support transmitting and receiving on demand SIB1 in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

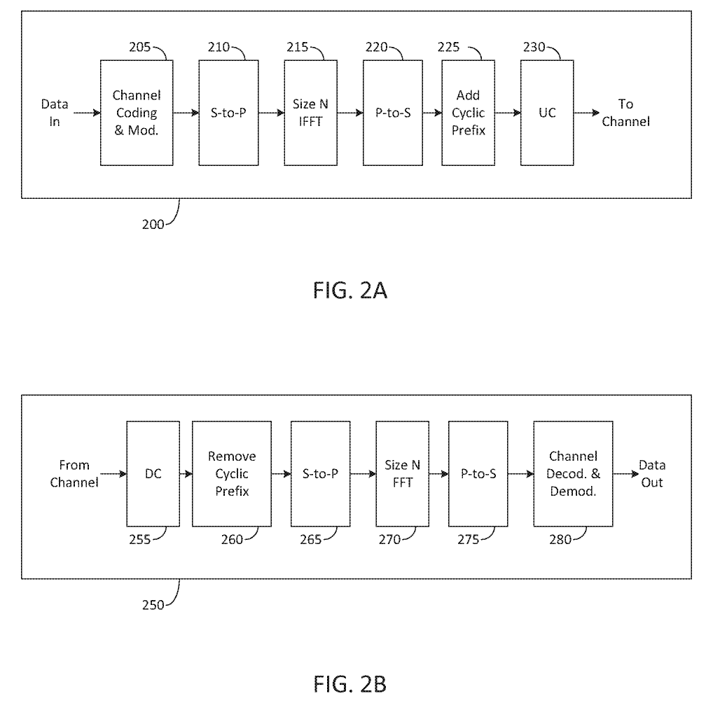

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support transmitting and receiving on demand SIB1 as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

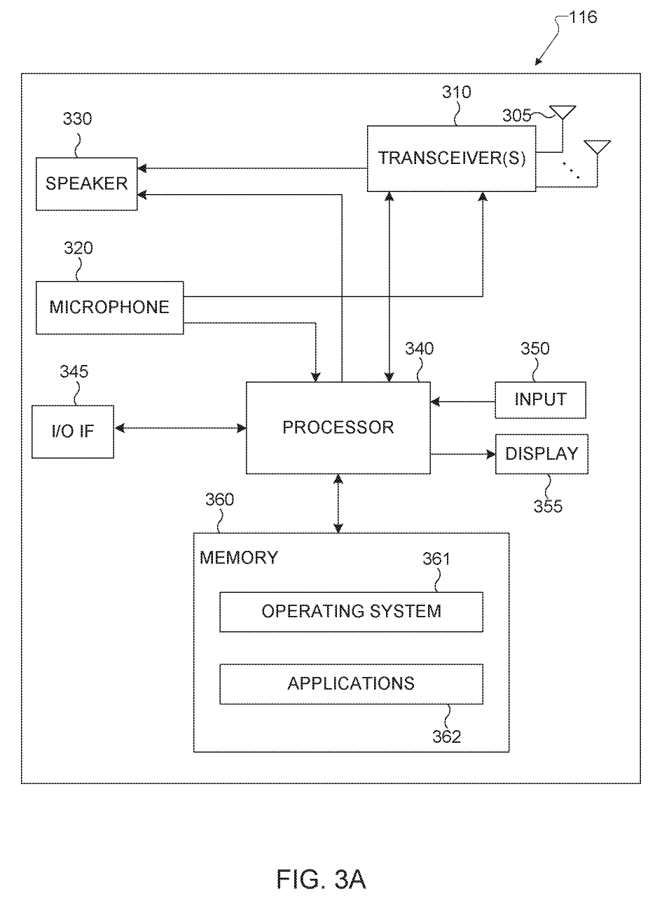

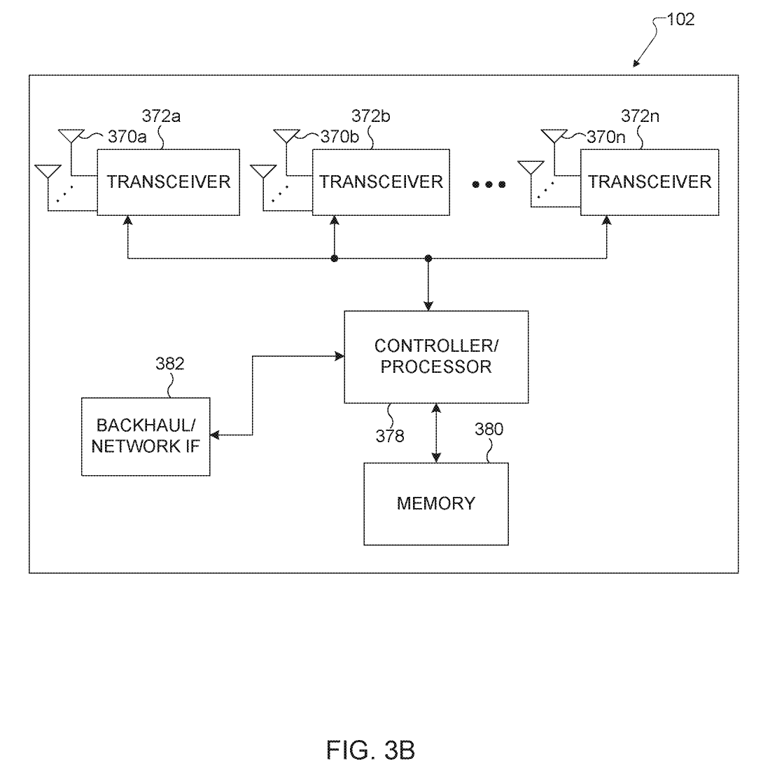

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for receiving on demand SIB1 as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support transmitting on demand SIB1as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/ DC the term 'serving cells' is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160ms and variable transmission repetition. The default transmission repetition periodicity of SIB1 is 20ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state or for a SIB1 request or for an SI request. Several types of random-access procedure are supported such as contention based random access, contention free random access and each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration ,where the slot with number ‘x’ in a radio frame with number ‘y’ satisfies the equation below: (y*(number of slots in a radio frame) + x – Monitoring-offset-PDCCH-slot) mod (Monitoring-periodicity-PDCCH-slot) = 0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the medium access control (MAC) entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In some wireless networks, a SIB1 is periodically transmitted in a cell by a gNB. In such networks, the SIB1 transmission periodicity may be 160ms with repetition at every 20ms within the 160ms interval. Periodic transmissions lead to increased network energy consumption. On demand SIB1 can enhance network energy savings wherein a cell can transmit a SIB1 upon receiving a request from a UE instead of periodically broadcasting the SIB1. In some embodiments, in the case of a beamformed system, upon receiving a SIB1 request from a UE, the SIB1 is transmitted using all beams (i.e., SSBs transmitted in the cell). Transmitting in all beams may consume more network energy. It is beneficial to transmit the SIB1 using a subset of transmitted SSBs to enhance network energy savings. Various embodiments of the present disclosure provide mechanisms for a UE to determine which of the transmitted SSBs in a cell are used by the network to transmit SIB1.

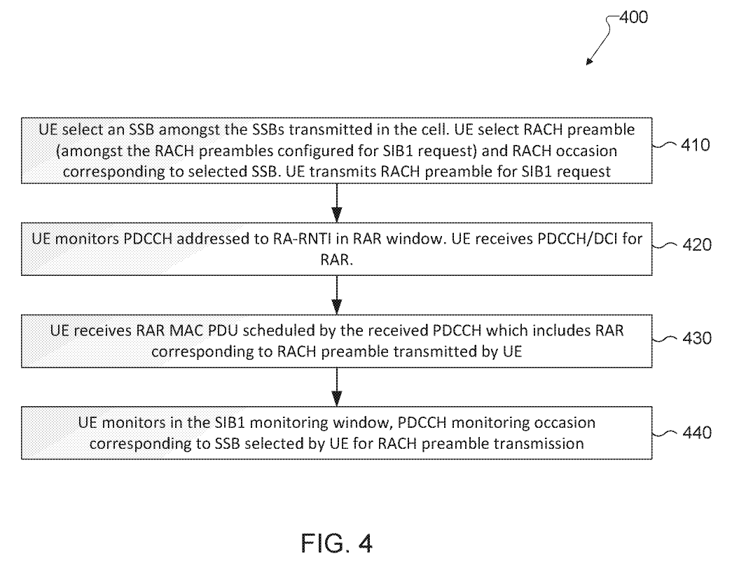

FIG. 4 illustrates an example procedure for transmitting and receiving SIB1 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for transmitting and receiving SIB1 could be used without departing from the scope of this disclosure.

In the example of FIG. 4, the procedure 400 begins at operation 410. At operation 410, a UE (such as UE 116 of FIG. 1) selects an SSB amongst the SSBs transmitted in the cell. In some embodiments, the selected SSB can be an SSB with a synchronization signal-reference signal received power (SS-RSRP) above a configured threshold or any SSB/SSB with a highest SS-RSRP if there is no SSB with an SS-RSRP above the configured threshold. The UE then selects a RACH preamble (amongst RACH preambles configured for a SIB1 request) and a RACH occasion corresponding to the selected SSB. The UE then transmits the selected RACH preamble for the SIB1 request in the selected RACH occasion to a gNB (such as gNB 102 of FIG. 1).

At operation 420, after transmitting the RACH preamble, the UE monitors a PDCCH addressed to a random access radio network temporary identifier (RA-RNTI) in a random access response (RAR) window. Then the UE receives a PDCCH/DCI addressed to an RA-RNTI for a RAR.

At operation 430, the UE receives a RAR MAC protocol data unit (PDU) scheduled by the received PDCCH/DCI. If the RAR MAC PDU includes a RAR corresponding to a random access preamble identifier (RAPID) of the RACH preamble transmitted by the UE, the RAR reception is considered successful and the UE considers this as acknowledgement for the SIB1 request from the gNB.

In some embodiments, at operation 440, after receiving the acknowledgement for the SIB1 request, the UE monitors in a SIB1 monitoring window, PDCCH monitoring occasion(s) corresponding to the SSB selected by the UE for a RACH preamble transmission, and the UE receives the SIB1 in the SIB1 monitoring window.

Alternatively, in some embodiments, at operation 440, after receiving the acknowledgement for the SIB1 request, the UE receives the SIB1 in the SIB1 monitoring window, wherein if the RRC/SI or SIB1 request configuration indicates that the SIB1 (i.e., a PDCCH/PDSCH for the SIB1) is transmitted using the SSB selected by the UE for the RACH preamble transmission, the UE monitors, in the SIB1 monitoring window, a PDCCH monitoring occasion corresponding to the SSB selected by the UE for the RACH preamble transmission. Otherwise (i.e., if the RRC/SI or SIB1 request configuration does not indicate that the SIB1 (i.e., a PDCCH/PDSCH for the SIB1) is transmitted using the SSB selected by the UE for the RACH preamble transmission), the UE monitors, in the SIB1 monitoring window, one or more PDCCH monitoring occasions corresponding to one or more SSB(s) transmitted in the cell.

Alternatively, in some embodiments, at operation 440, after receiving the acknowledgement for the SIB1 request, if the RRC/SI or SIB1 request configuration indicates that the SIB1 (i.e., a PDCCH/PDSCH for the SIB1) is transmitted using a subset of SSBs amongst the SSBs transmitted in cell, the UE monitors in a SIB1 monitoring window, one or more PDCCH monitoring occasion(s) corresponding to one or more SSBs amongst the subset of SSBs, wherein the subset of SSBs is signaled by an RRC/SI or SIB1 request configuration. Otherwise, the UE monitors in the SIB1 monitoring window one or more PDCCH monitoring occasions corresponding to one or more SSB(s) transmitted in the cell. Then the UE receives the SIB1 in the SIB1 monitoring window.

Although FIG. 4 illustrates one example procedure for transmitting and receiving SIB1 400, various changes may be made to FIG. 4. For example, while shown as a series of operations, various operations in FIG. 4 could overlap, occur in parallel, occur in a different order, occur any number of times, be omitted, or replaced by other operations.

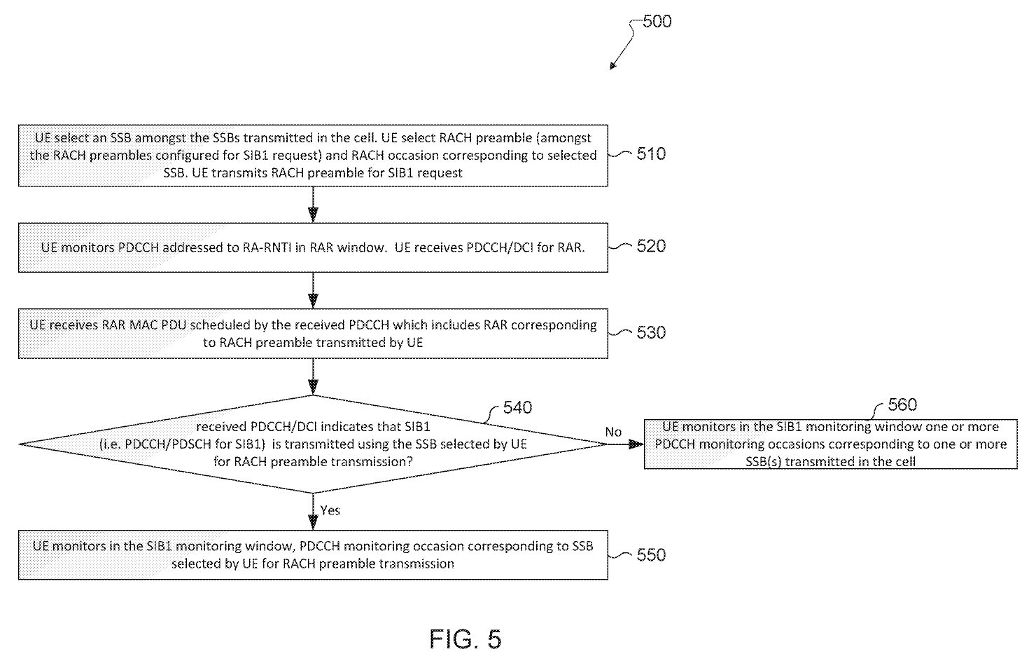

FIG. 5 illustrates another example procedure for transmitting and receiving SIB1 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for transmitting and receiving SIB1 could be used without departing from the scope of this disclosure.

In the example of FIG. 5, the procedure 500 begins at operation 510. At operation 510, a UE (such as UE 116 of FIG. 1) selects an SSB amongst the SSBs transmitted in the cell. In some embodiments, the selected SSB can be an SSB with an SS-RSRP above a configured threshold or any SSB/SSB with a highest SS-RSRP if there is no SSB with an SS-RSRP above the configured threshold. The UE then selects a RACH preamble (amongst RACH preambles configured for a SIB1 request) and a RACH occasion corresponding to the selected SSB. The UE then transmits the selected RACH preamble for the SIB1 request in the selected RACH occasion to a gNB (such as gNB 102 of FIG. 1).

At operation 520, after transmitting the RACH preamble, the UE monitors a PDCCH addressed to an RA-RNTI in a RAR window. Then the UE receives a PDCCH/DCI addressed to an RA-RNTI for a RAR. The PDCCH/DCI indicates whether the SIB1 (i.e., a PDCCH/PDSCH for the SIB1) is transmitted using an SSB (where using an SSB means QCled with an SSB in a spatial domain) selected by the UE for RACH preamble transmission. For example, in some embodiments, one bit can be included in the DCI, wherein the bit can be set to 1 to indicate that the SIB1 (i.e., a PDCCH/PDSCH for the SIB1) is transmitted using an SSB selected by the UE for the RACH preamble transmission and the bit can be set to 0 to indicate that the SIB1 (i.e., a PDCCH/PDSCH for the SIB1) is transmitted using all SSBs transmitted in the cell. Alternatively, in some embodiments, one bit can be included in the DCI, wherein the bit can be set to 0 to indicate that the SIB1 (i.e., a PDCCH/PDSCH for the SIB1) is transmitted using the SSB selected by the UE for the RACH preamble transmission and the bit can be set to 1 to indicate that the SIB1 (i.e., a PDCCH/PDSCH for the SIB1) is transmitted using all SSBs transmitted in the cell.

At operation 530, the UE receives a RAR MAC PDU scheduled by the received PDCCH/DCI. If the RAR MAC PDU includes a RAR corresponding to a RAPID of the RACH preamble transmitted by the UE, the RAR reception is considered successful and the UE considers this as acknowledgement for the SIB1 request from the gNB.

At operation 540, after receiving the acknowledgement for the SIB1 request, if the PDCCH/DCI received at operation 520 indicates that the SIB1 (i.e., a PDCCH/PDSCH for the SIB1) is transmitted using the SSB selected by the UE for the RACH preamble transmission, the procedure 500 proceeds to operation 550. Otherwise, the procedure 500 proceeds to operation 560.

At operation 560, the UE monitors in the SIB1 monitoring window, a PDCCH monitoring occasion corresponding to the SSB selected by the UE for the RACH preamble transmission, and receives the SIB1 in the SIB1 monitoring window.

At operation 570, the UE monitors in the SIB1 monitoring window one or more PDCCH monitoring occasions corresponding to one or more SSB(s) transmitted in the cell, and receives the SIB1 in the SIB1 monitoring window.

Although FIG. 5 illustrates one example procedure for transmitting and receiving SIB1 500, various changes may be made to FIG. 5. For example, while shown as a series of operations, various operations in FIG. 5 could overlap, occur in parallel, occur in a different order, occur any number of times, be omitted, or replaced by other operations.

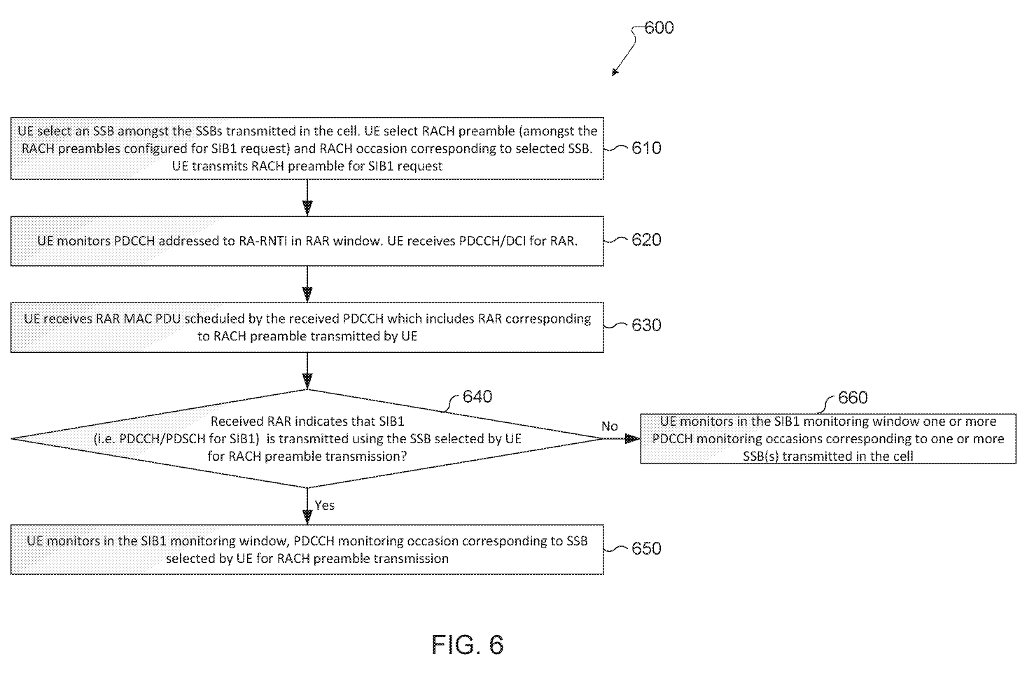

FIG. 6 illustrates another example procedure for transmitting and receiving SIB1 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for transmitting and receiving SIB1 could be used without departing from the scope of this disclosure.

In the example of FIG. 6, the procedure 600 begins at operation 610. At operation 610, a UE (such as UE 116 of FIG. 1) selects an SSB amongst the SSBs transmitted in the cell. In some embodiments, the selected SSB can be an SSB with an SS-RSRP above a configured threshold or any SSB/SSB with a highest SS-RSRP if there is no SSB with an SS-RSRP above the configured threshold. The UE then selects a RACH preamble (amongst RACH preambles configured for a SIB1 request) and a RACH occasion corresponding to the selected SSB. The UE then transmits the selected RACH preamble for the SIB1 request in the selected RACH occasion to a gNB (such as gNB 102 of FIG. 1).

At operation 620, after transmitting the RACH preamble, the UE monitors a PDCCH addressed to an RA-RNTI in a RAR window. Then the UE receives a PDCCH/DCI addressed to an RA-RNTI for a RAR.

At operation 630, the UE receives a RAR MAC PDU scheduled by the received PDCCH/DCI. If the RAR MAC PDU includes a RAR corresponding to a RAPID of the RACH preamble transmitted by the UE, the RAR reception is considered successful and the UE considers this as acknowledgement for the SIB1 request from the gNB. The RAR subPDU corresponding to the RACH preamble transmitted by UE indicates whether the SIB1 (i.e., a PDCCH/PDSCH for the SIB1) is transmitted using the SSB (where using an SSB means QCled with an SSB in the spatial domain) selected by the UE for the RACH preamble transmission. In some embodiments, one bit can be included in the RAR subPDU corresponding to the RACH preamble transmitted by the UE, wherein the bit can be set to 1 to indicate that the SIB1 (i.e., a PDCCH/PDSCH for the SIB1) is transmitted using the SSB selected by the UE for the RACH preamble transmission and the bit can be set to 0 to indicate that the SIB1 (i.e., a PDCCH/PDSCH for the SIB1) is transmitted using all SSBs transmitted in the cell. Alternatively, in some embodiments, one bit can be included in the RAR subPDU corresponding to the RACH preamble transmitted by the UE, wherein the bit can be set to 0 to indicate that the SIB1 (i.e., a PDCCH/PDSCH for the SIB1) is transmitted using the SSB selected by the UE for the RACH preamble transmission and the bit can be set to 1 to indicate that the SIB1 (i.e., a PDCCH/PDSCH for the SIB1) is transmitted is using all SSBs transmitted in the cell.

In some embodiments, a size of the RAR subPDU payload in the RAR MAC PDU for the RACH preamble transmission for the SIB1 request is the same (i.e., 7 octets) as a RAR subPDU for a RACH preamble transmission for other events. In some embodiments, the RAR subPDU payload for the RACH preamble transmission for the SIB1 request may include 1 bit for SSB indication and may include 55 R bits. The advantage of this is that a RAR for a SIB1 request and a RAR for other events can be multiplexed in the same RAR MAC PDU. In some embodiments, a RAR subPDU for the SIB1 request is not multiplexed with a RAR subPDU(s) for other than a SIB1 request in the same RAR MAC PDU and RAR search space for the SIB1 request can be separately configured from the RAR search space for other random access events.

At operation 640, after receiving the acknowledgement for the SIB1 request, if the RAR subPDU corresponding to the RACH preamble transmitted by the UE received in operation 630 indicates that the SIB1 (i.e., a PDCCH/PDSCH for the SIB1) is transmitted using the SSB selected by the UE for the RACH preamble transmission, the procedure 600 proceeds to operation 650. Otherwise, the procedure 600 proceeds to operation 660.

At operation 660, the UE monitors in the SIB1 monitoring window, a PDCCH monitoring occasion corresponding to the SSB selected by the UE for the RACH preamble transmission, and receives the SIB1 in the SIB1 monitoring window.

At operation 670, the UE monitors in the SIB1 monitoring window one or more PDCCH monitoring occasions corresponding to one or more SSB(s) transmitted in the cell, and receives the SIB1 in the SIB1 monitoring window.

Although FIG. 6 illustrates one example procedure for transmitting and receiving SIB1 600, various changes may be made to FIG. 6. For example, while shown as a series of operations, various operations in FIG. 6 could overlap, occur in parallel, occur in a different order, occur any number of times, be omitted, or replaced by other operations.

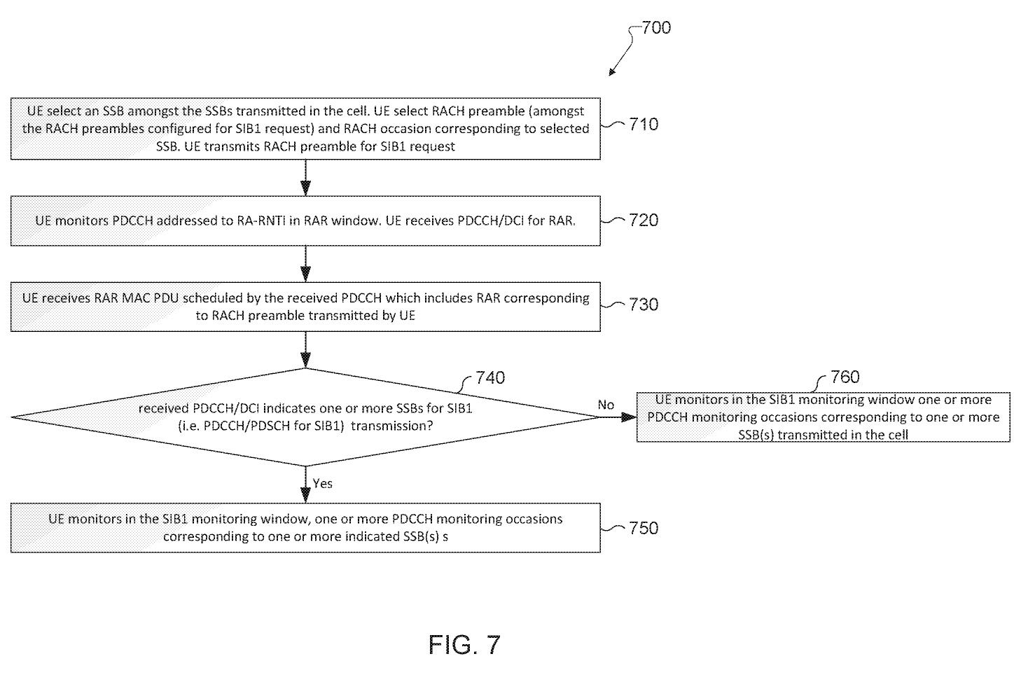

FIG. 7 illustrates another example procedure for transmitting and receiving SIB1 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for transmitting and receiving SIB1 could be used without departing from the scope of this disclosure.

In the example of FIG. 7, the procedure 700 begins at operation 710. At operation 710, a UE (such as UE 116 of FIG. 1) selects an SSB amongst the SSBs transmitted in the cell. In some embodiments, the selected SSB can be an SSB with an SS-RSRP above a configured threshold or any SSB/SSB with a highest SS-RSRP if there is no SSB with an SS-RSRP above the configured threshold. The UE then selects a RACH preamble (amongst RACH preambles configured for a SIB1 request) and a RACH occasion corresponding to the selected SSB. The UE then transmits the selected RACH preamble for the SIB1 request in the selected RACH occasion to a gNB (such as gNB 102 of FIG. 1).

At operation 720, after transmitting the RACH preamble, the UE monitors a PDCCH addressed to an RA-RNTI in a RAR window. Then the UE receives a PDCCH/DCI addressed to an RA-RNTI for a RAR. The DCI indicates one or more SSBs amongst the SSBs transmitted in the cell, wherein the SIB1 (i.e., a PDCCH/PDSCH for the SIB1) is transmitted using these indicated SSBs (where using an SSB means QCled with an SSB in the spatial domain). For example, in some embodiments, the SSBs can be indicated in the DCI by explicitly including SSB IDs or by including a bitmap, wherein each bit corresponds to an SSB transmitted in the cell. In embodiments such as these, a bit corresponding to an SSB in bitmap can be set to 1 to indicate that the SIB1 (i.e., a PDCCH/PDSCH for the SIB1) is transmitted using this SSB. Otherwise, the bit is set to 0. Alternately, in some embodiments, a bit corresponding to an SSB in bitmap can be set to 0 to indicate that the SIB1 (i.e., a PDCCH/PDSCH for the SIB1) is transmitted using this SSB. Otherwise, the bit is set to 1. In some embodiments, bits in a bitmap can be mapped to SSBs in ascending order of SSB IDs from least significant bit (lsb) to most significant bit (msb) or from msb to lsb. In some embodiments, bits in a bitmap can be mapped to SSBs in ascending order of SSB IDs from lsb to msb or from msb to lsb.

At operation 730, the UE receives a RAR MAC PDU scheduled by the received PDCCH/DCI. If the RAR MAC PDU includes a RAR corresponding to a RAPID of the RACH preamble transmitted by the UE, the RAR reception is considered successful and the UE considers this as acknowledgement for the SIB1 request from the gNB.

At operation 740, after receiving the acknowledgement for the SIB1 request, if the DCI received at operation 720 indicates the SSBs used for the SIB1 (i.e., a PDCCH/PDSCH for the SIB1) transmission, the procedure 700 proceeds to operation 750. Otherwise, the procedure 700 proceeds to operation 760.

At operation 760, the UE monitors in the SIB1 monitoring window, one or more PDCCH monitoring occasion(s) corresponding to one or more indicated SSB(s) in the DCI, and receives the SIB1 in the SIB1 monitoring window.

At operation 770, the UE monitors in the SIB1 monitoring window one or more PDCCH monitoring occasions corresponding to one or more SSB(s) transmitted in the cell, and receives the SIB1 in the SIB1 monitoring window.

Although FIG. 7 illustrates one example procedure for transmitting and receiving SIB1 700, various changes may be made to FIG. 7. For example, while shown as a series of operations, various operations in FIG. 7 could overlap, occur in parallel, occur in a different order, occur any number of times, be omitted, or replaced by other operations.

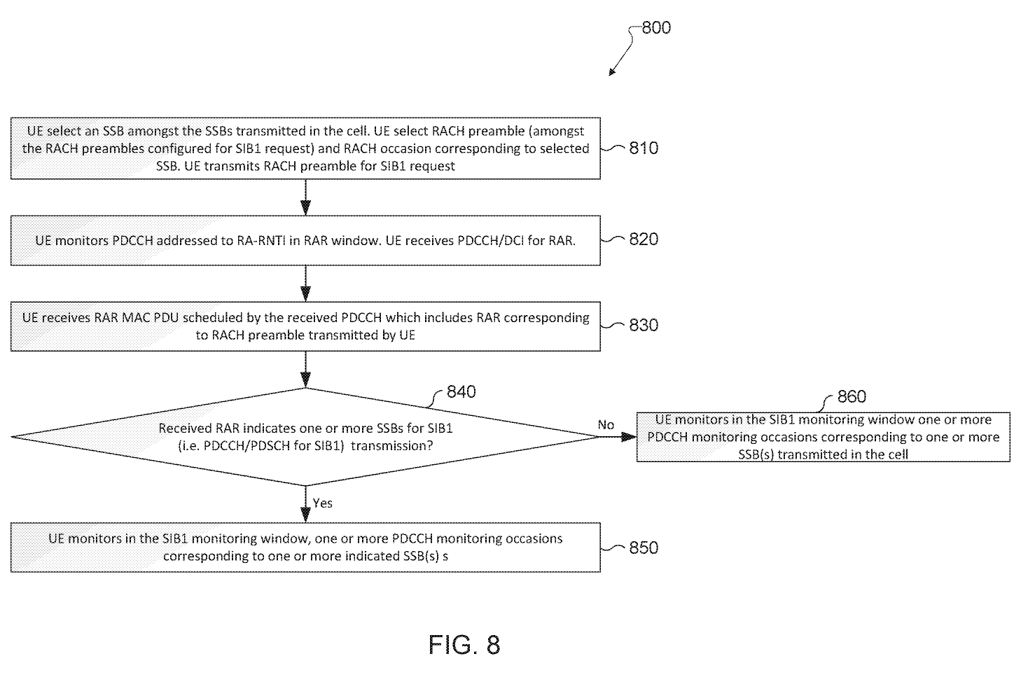

FIG. 8 illustrates another example procedure for transmitting and receiving SIB1 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for transmitting and receiving SIB1 could be used without departing from the scope of this disclosure.

In the example of FIG. 8, the procedure 800 begins at operation 810. At operation 810, a UE (such as UE 116 of FIG. 1) selects an SSB amongst the SSBs transmitted in the cell. In some embodiments, the selected SSB can be an SSB with an SS-RSRP above a configured threshold or any SSB/SSB with a highest SS-RSRP if there is no SSB with an SS-RSRP above the configured threshold. The UE then selects a RACH preamble (amongst RACH preambles configured for a SIB1 request) and a RACH occasion corresponding to the selected SSB. The UE then transmits the selected RACH preamble for the SIB1 request in the selected RACH occasion to a gNB (such as gNB 102 of FIG. 1).

At operation 820, after transmitting the RACH preamble, the UE monitors a PDCCH addressed to an RA-RNTI in a RAR window. Then the UE receives a PDCCH/DCI addressed to an RA-RNTI for a RAR.

At operation 830, the UE receives a RAR MAC PDU scheduled by the received PDCCH. If the RAR MAC PDU includes a RAR corresponding to a RAPID of the RACH preamble transmitted by the UE, the RAR reception is considered successful and the UE considers this as acknowledgement for the SIB1 request from the gNB. The RAR corresponding to the RAPID of the RACH preamble transmitted by the UE indicates one or more SSBs amongst the SSBs transmitted in the cell, wherein the SIB1 (i.e., a PDCCH/PDSCH for the SIB1) is transmitted using these indicated SSBs (where using an SSB means QCled with an SSB in the spatial domain). In some embodiments, the SSBs can be indicated in a RAR by explicitly including SSB IDs or by including a bitmap wherein each bit corresponds to an SSB transmitted in the cell. For example, in some embodiments, a bit corresponding to an SSB in bitmap can be set to 1 to indicate that the SIB1 (i.e., a PDCCH/PDSCH for the SIB1) is transmitted using this SSB. Otherwise, the bit is set to 0. Alternatively, in some embodiments, a bit corresponding to an SSB in bitmap can be set to 0 to indicate that the SIB1 (i.e., a PDCCH/PDSCH for the SIB1) is transmitted using this SSB. Otherwise, the bit is set to 1. In some embodiments, bits in a bitmap can be mapped to SSBs in ascending order of SSB IDs from lsb to msb or from msb to lsb. In some embodiments, bits in a bitmap can be mapped to SSBs in ascending order of SSB IDs from lsb to msb or from msb to lsb.

In some embodiments, a size of this RAR subPDU payload in the RAR MAC PDU for the RACH preamble transmission for the SIB1 request is the same (i.e., 7 octets) as a RAR subPDU for a RACH preamble transmission for other events. This RAR subPDU payload for the RACH preamble transmission for the SIB1 request includes an indication of SSB(s) and may include unused R bits. The advantage of this is that the RAR for the SIB1 request and the RAR for other events can be multiplexed in the same RAR MAC PDU. In some embodiments, a RAR subPDU for the SIB1 request is not multiplexed with a RAR subPDU(s) for other than the SIB1 request in the same RAR MAC PDU and a RAR search space for the SIB1 request can be separately configured from a RAR search space for other random access events.

At operation 840, after receiving the acknowledgement for the SIB1 request, if the RAR received at operation 830 indicates the SSBs used for the SIB1 (i.e., a PDCCH/PDSCH for the SIB1) transmission, the procedure 800 proceeds to operation 850. Otherwise, the procedure 800 proceeds to operation 860.

At operation 860, the UE monitors in the SIB1 monitoring window, one or more PDCCH monitoring occasion(s) corresponding to one or more indicated SSB(s) in the RAR, and receives the SIB1 in the SIB1 monitoring window.

At operation 870, the UE monitors in the SIB1 monitoring window one or more PDCCH monitoring occasions corresponding to one or more SSB(s) transmitted in the cell, and receives the SIB1 in the SIB1 monitoring window.

Although FIG. 8 illustrates one example procedure for transmitting and receiving SIB1 800, various changes may be made to FIG. 8. For example, while shown as a series of operations, various operations in FIG. 8 could overlap, occur in parallel, occur in a different order, occur any number of times, be omitted, or replaced by other operations.

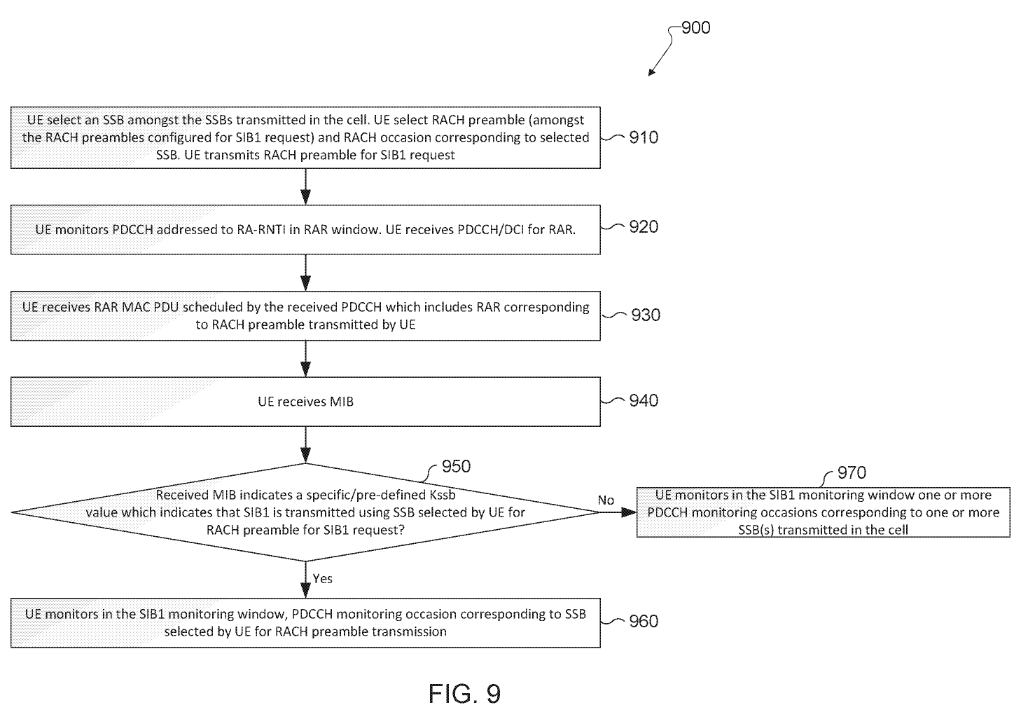

FIG. 9 illustrates another example procedure for transmitting and receiving SIB1 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for transmitting and receiving SIB1 could be used without departing from the scope of this disclosure.

In the example of FIG. 9, the procedure 900 begins at operation 910. At operation 910, a UE (such as UE 116 of FIG. 1) selects an SSB amongst the SSBs transmitted in the cell. In some embodiments, the selected SSB can be an SSB with an SS-RSRP above a configured threshold or any SSB/SSB with a highest SS-RSRP if there is no SSB with an SS-RSRP above the configured threshold. The UE then selects a RACH preamble (amongst RACH preambles configured for a SIB1 request) and a RACH occasion corresponding to the selected SSB. The UE then transmits the selected RACH preamble for the SIB1 request in the selected RACH occasion to a gNB (such as gNB 102 of FIG. 1).

At operation 920, after transmitting the RACH preamble, the UE monitors a PDCCH addressed to an RA-RNTI in a RAR window. Then the UE receives a PDCCH/DCI addressed to an RA-RNTI for a RAR.

At operation 930, the UE receives a RAR MAC PDU scheduled by the received PDCCH/DCI. If the RAR MAC PDU includes a RAR corresponding to a RAPID of the RACH preamble transmitted by the UE, the RAR reception is considered successful and the UE considers this as acknowledgement for the SIB1 request from the gNB.

At operation 940, after receiving the acknowledgement for the SIB1 request, the UE receives a MIB.

In some embodiments, at operation 950, if the received MIB indicates a specific/pre-defined Kssb value (e.g., other than a Kssb value which indicates SIB1 transmission) which indicates that the SIB1 is transmitted using the SSB selected by the UE for the RACH preamble for the SIB1 request, then procedure 900 proceeds to operation 960. Otherwise, procedure 900 proceeds to operation 970.

Alternatively, in some embodiments, at operation 950, if the received MIB indicates a specific/pre-defined Kssb value (e.g., other than a Kssb value which indicates SIB1 transmission) which indicates that the SIB1 is transmitted using a subset of SSBs transmitted in the cell, wherein the subset of SSBs is signaled to the UE in the SIB1 request configuration or in a DCI for a RAR, or in a RAR, then procedure 900 proceeds to operation 960. Otherwise, procedure 900 proceeds to operation 970.

At operation 960, the UE monitors in the SIB1 monitoring window, a PDCCH monitoring occasion corresponding to the SSB selected by the UE for the RACH preamble transmission (or one or more PDCCH monitoring occasions corresponding to one or more SSB(s) amongst the subset of SSBs).

At operation 970, the UE monitors in the SIB1 monitoring window one or more PDCCH monitoring occasions corresponding to one or more SSB(s) transmitted in the cell.

Although FIG. 9 illustrates one example procedure for transmitting and receiving SIB1 900, various changes may be made to FIG. 9. For example, while shown as a series of operations, various operations in FIG. 9 could overlap, occur in parallel, occur in a different order, occur any number of times, be omitted, or replaced by other operations.

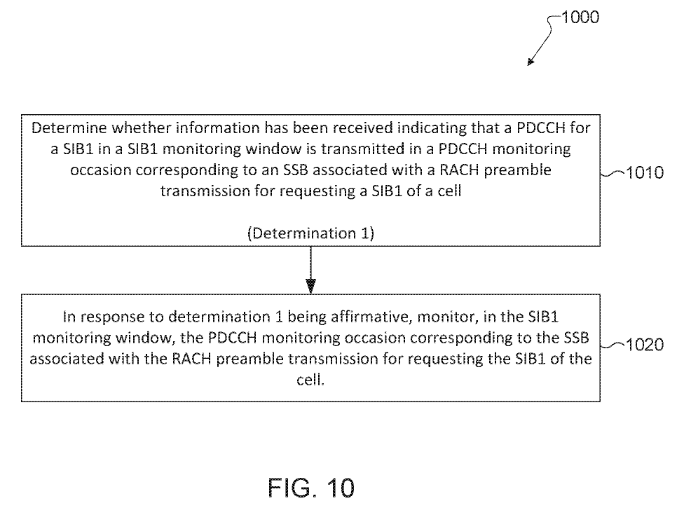

FIG. 10 illustrates an example method for transmitting and receiving SIB1 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for transmitting and receiving SIB1 could be used without departing from the scope of this disclosure.

In the example of FIG. 10, the method 1000 begins at step 1010. At step 1010, a UE (such as UE 116 of FIG. 1) determines whether the UE has received information indicating that a PDCCH for a SIB1 in a SIB1 monitoring window is transmitted in a PDCCH monitoring occasion corresponding to an SSB associated with a RACH preamble transmission for requesting a SIB1 of a cell. This determination may be referred to as a “first determination” or “determination 1.”

At step 1020, the first determination is affirmative, the UE monitors, in the SIB1 monitoring window, the PDCCH monitoring occasion corresponding to the SSB associated with the RACH preamble transmission for requesting the SIB1 of the cell.

In some embodiments, the UE may receive a configuration for requesting the SIB1 of the cell. In embodiments such as these, the information indicating that the PDCCH for the SIB1 in the SIB1 monitoring window is transmitted in the PDCCH monitoring occasion corresponding to the SSB associated with the RACH preamble transmission for requesting the SIB1 of the cell may be received in the configuration for requesting the SIB1 of the cell.

In some embodiments, the UE may receive a RAR corresponding to the RACH preamble transmission for requesting the SIB1 of the cell. In embodiments such as these, the information indicating that the PDCCH for the SIB1 in the SIB1 monitoring window is transmitted in the PDCCH monitoring occasion corresponding to the SSB associated with the RACH preamble transmission for requesting the SIB1 of the cell may be received in the RAR.

In some embodiments, the UE may receive DCI scheduling a RAR corresponding to the RACH preamble transmission for requesting the SIB1 of the cell. In embodiments such as these, the information indicating that the PDCCH for the SIB1 in the SIB1 monitoring window is transmitted in the PDCCH monitoring occasion corresponding to the SSB associated with the RACH preamble transmission for requesting the SIB1 of the cell may be received in the DCI scheduling the RAR.

In some embodiments, in response to the first determination being negative, the UE may monitor, in the SIB1 monitoring window, one or more PDDCH monitoring occasions corresponding to one or more SSBs transmitted in the cell.

In some embodiments, the SSB associated with the RACH preamble transmission for requesting the SIB1 of the cell may be an SSB amongst SSBs transmitted in the cell with an SS-RSRP above a configured threshold, or in circumstances where there is no SSB amongst the SSBs transmitted in the cell with an SS-RRSP above the configured threshold, any SSB amongst the SSBs transmitted in the cell.

In some embodiments, the UE may receive a RAR corresponding to the RACH preamble transmission for requesting the SIB1 of the cell. In embodiments such as these, the UE may begin the PDCCH monitoring in response to the first determination being affirmative after receiving the RAR.

Although FIG. 10 illustrates one example method for transmitting and receiving SIB1 1000, various changes may be made to FIG. 10. For example, while shown as a series of steps, various steps in FIG. 10 could overlap, occur in parallel, occur in a different order, occur any number of times, be omitted, or replaced by other steps.

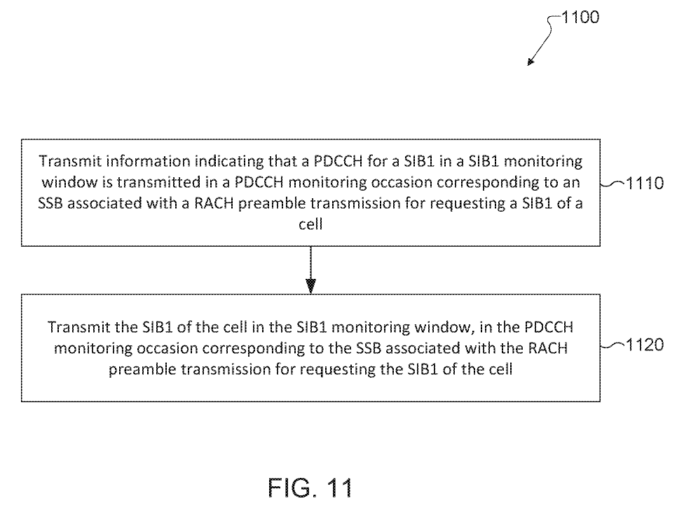

FIG. 11 illustrates an example method for transmitting and receiving SIB1 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for transmitting and receiving SIB1 could be used without departing from the scope of this disclosure.

In the example of FIG. 11, the method 1100 begins at step 1110. At step 1110, a BS (such as BS 02 of FIG. 1) transmits information indicating that a PDCCH for a SIB1 in a SIB1 monitoring window is transmitted in a PDCCH monitoring occasion corresponding to an SSB associated with a RACH preamble transmission for requesting a SIB1 of a cell.

At step 1120, the BS transmits the SIB1 of the cell in the SIB1 monitoring window, in the PDCCH monitoring occasion corresponding to the SSB associated with the RACH preamble transmission for requesting the SIB1 of the cell.

In some embodiments, the BS may transmit a configuration for requesting the SIB1 of the cell. In embodiments such as these, the information indicating that the PDCCH for the SIB1 in the SIB1 monitoring window is transmitted in the PDCCH monitoring occasion corresponding to the SSB associated with the RACH preamble transmission for requesting the SIB1 of the cell may be transmitted in the configuration for requesting the SIB1 of the cell.

In some embodiments, the BS may transmit a RAR corresponding to the RACH preamble transmission for requesting the SIB1 of the cell to a UE. In embodiments such as these, the information indicating that the PDCCH for the SIB1 in the SIB1 monitoring window is transmitted in the PDCCH monitoring occasion corresponding to the SSB associated with the RACH preamble transmission for requesting the SIB1 of the cell may be transmitted in the RAR.

In some embodiments, the BS may transmit DCI to a UE scheduling a RAR corresponding to the RACH preamble transmission for requesting the SIB1 of the cell. In embodiments such as these, the information indicating that the PDCCH for the SIB1 in the SIB1 monitoring window is transmitted in the PDCCH monitoring occasion corresponding to the SSB associated with the RACH preamble transmission for requesting the SIB1 of the cell may be transmitted in the DCI scheduling the RAR.

In some embodiments, the SSB associated with the RACH preamble transmission for requesting the SIB1 of the cell may be an SSB amongst SSBs transmitted in the cell with an SS-RSRP above a configured threshold, or in circumstances where there is no SSB amongst the SSBs transmitted in the cell with an SS-RRSP above the configured threshold, any SSB amongst the SSBs transmitted in the cell.

In some embodiments, the BS may transmit a RAR corresponding to the RACH preamble transmission for requesting the SIB1 of the cell to a UE. In embodiments such as these, the SIB1 of the cell may be transmitted to the UE in the SIB1 monitoring window after transmission of the RAR.

Although FIG. 11 illustrates one example method for transmitting and receiving SIB1 1100, various changes may be made to FIG. 11. For example, while shown as a series of steps, various steps in FIG. 11 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
determining a first determination whether the UE has received information indicating that a physical downlink control channel (PDCCH) for a system information block 1 (SIB1) in a SIB1 monitoring window is transmitted in a PDCCH monitoring occasion corresponding to a synchronization signal block (SSB) associated with a random access channel (RACH) preamble transmission for requesting a SIB1 of a cell; and
in response to the first determination being affirmative, monitoring, in the SIB1 monitoring window, the PDCCH monitoring occasion corresponding to the SSB associated with the RACH preamble transmission for requesting the SIB1 of the cell.

2. The method of claim 1, further comprising receiving a configuration for requesting the SIB1 of the cell,
wherein the information indicating that the PDCCH for the SIB1 in the SIB1 monitoring window is transmitted in the PDCCH monitoring occasion corresponding to the SSB associated with the RACH preamble transmission for requesting the SIB1 of the cell is received in the configuration for requesting the SIB1 of the cell.

3. The method of claim 1, further comprising receiving a random access response (RAR) corresponding to the RACH preamble transmission for requesting the SIB1 of the cell,
wherein the information indicating that the PDCCH for the SIB1 in the SIB1 monitoring window is transmitted in the PDCCH monitoring occasion corresponding to the SSB associated with the RACH preamble transmission for requesting the SIB1 of the cell is received in the RAR.

4. The method of claim 1, further comprising receiving downlink control information (DCI) scheduling a random access response (RAR) corresponding to the RACH preamble transmission for requesting the SIB1 of the cell,
wherein the information indicating that the PDCCH for the SIB1 in the SIB1 monitoring window is transmitted in the PDCCH monitoring occasion corresponding to the SSB associated with the RACH preamble transmission for requesting the SIB1 of the cell is received in the DCI scheduling the RAR.

5. The method of claim 1, further comprising, in response to the first determination being negative, monitoring, in the SIB1 monitoring window, one or more PDDCH monitoring occasions corresponding to one or more SSBs transmitted in the cell.

6. The method of claim 1, wherein the SSB associated with the RACH preamble transmission for requesting the SIB1 of the cell is:
an SSB amongst SSBs transmitted in the cell with a synchronization signal-reference signal received power (SS-RSRP) above a configured threshold; or
in circumstances where there is no SSB amongst the SSBs transmitted in the cell with an SS-RRSP above the configured threshold, any SSB amongst the SSBs transmitted in the cell.

7. The method of claim 1, further comprising receiving a random access response (RAR) corresponding to the RACH preamble transmission for requesting the SIB1 of the cell,
wherein the UE begins the PDCCH monitoring in response to the first determination being affirmative after receiving the RAR.

8. A method of operating a base station (BS), the method comprising:
transmitting information indicating that a physical downlink control channel (PDCCH) for a system information block 1 (SIB1) in a SIB1 monitoring window is transmitted in a PDCCH monitoring occasion corresponding to a synchronization signal block (SSB) associated with a random access channel (RACH) preamble transmission for requesting a SIB1 of a cell; and
transmitting the SIB 1 of the cell in the SIB1 monitoring window, in the PDCCH monitoring occasion corresponding to the SSB associated with the RACH preamble transmission for requesting the SIB1 of the cell.

9. The method of claim 8, further comprising transmitting a configuration for requesting the SIB1 of the cell,
wherein the information indicating that the PDCCH for the SIB1 in the SIB1 monitoring window is transmitted in the PDCCH monitoring occasion corresponding to the SSB associated with the RACH preamble transmission for requesting the SIB1 of the cell is transmitted in the configuration for requesting the SIB1 of the cell.

10. The method of claim 8, further comprising transmitting a random access response (RAR) corresponding to the RACH preamble transmission for requesting the SIB1 of the cell to a user equipment (UE),
wherein the information indicating that the PDCCH for the SIB1 in the SIB1 monitoring window is transmitted in the PDCCH monitoring occasion corresponding to the SSB associated with the RACH preamble transmission for requesting the SIB1 of the cell is transmitted in the RAR.

11. The method of claim 8, further comprising transmitting downlink control information (DCI) to a user equipment (UE) scheduling a random access response (RAR) corresponding to the RACH preamble transmission for requesting the SIB1 of the cell,
wherein the information indicating that the PDCCH for the SIB1 in the SIB1 monitoring window is transmitted in the PDCCH monitoring occasion corresponding to the SSB associated with the RACH preamble transmission for requesting the SIB1 of the cell is transmitted in the DCI scheduling the RAR.

12. The method of claim 8, wherein the SSB associated with the RACH preamble transmission for requesting the SIB1 of the cell is:
an SSB amongst SSBs transmitted in the cell with a synchronization signal-reference signal received power (SS-RSRP) above a configured threshold; or
in circumstances where there is no SSB amongst the SSBs transmitted in the cell with an SS-RRSP above the configured threshold, any SSB amongst the SSBs transmitted in the cell.

13. The method of claim 8, further comprising transmitting a random access response (RAR) corresponding to the RACH preamble transmission for requesting the SIB1 of the cell to a user equipment (UE),
wherein the SIB1 of the cell is transmitted to the UE in the SIB1 monitoring window after transmission of the RAR.

14. An electronic device comprising:
at least one processor including processing circuitry; and
memory storing instructions, wherein the instructions, when executed by the at least one processor individually or collectively, cause the electronic device to:
determine a first determination whether the electronic device has received information indicating that a physical downlink control channel (PDCCH) for a system information block 1 (SIB1) in a SIB1 monitoring window is transmitted in a PDCCH monitoring occasion corresponding to a synchronization signal block (SSB) associated with a random access channel (RACH) preamble transmission for requesting a SIB1 of a cell; and
in response to the first determination being affirmative, monitor, in the SIB1 monitoring window, the PDCCH monitoring occasion corresponding to the SSB associated with the RACH preamble transmission for requesting the SIB1 of the cell.

15. The electronic device of claim 14, wherein:
the instructions, when executed by the at least one processor individually or collectively, further cause the electronic device to receive a configuration for requesting the SIB1 of the cell; and
the information indicating that the PDCCH for the SIB1 in the SIB1 monitoring window is transmitted in the PDCCH monitoring occasion corresponding to the SSB associated with the RACH preamble transmission for requesting the SIB1 of the cell is received in the configuration for requesting the SIB1 of the cell.

16. The electronic device of claim 14, wherein:
the instructions, when executed by the at least one processor individually or collectively, further cause the electronic device to receive a random access response (RAR) corresponding to the RACH preamble transmission for requesting the SIB1 of the cell; and
the information indicating that the PDCCH for the SIB1 in the SIB1 monitoring window is transmitted in the PDCCH monitoring occasion corresponding to the SSB associated with the RACH preamble transmission for requesting the SIB1 of the cell is received in the RAR.

17. The electronic device of claim 14, wherein:
the instructions, when executed by the at least one processor individually or collectively, further cause the electronic device to receive downlink control information (DCI) scheduling a random access response (RAR) corresponding to the RACH preamble transmission for requesting the SIB1 of the cell; and
the information indicating that the PDCCH for the SIB1 in the SIB1 monitoring window is transmitted in the PDCCH monitoring occasion corresponding to the SSB associated with the RACH preamble transmission for requesting the SIB1 of the cell is received in the DCI scheduling the RAR.

18. The electronic device of claim 14, wherein the instructions, when executed by the at least one processor individually or collectively, further cause the electronic device to, in response to the first determination being negative, monitor, in the SIB1 monitoring window, one or more PDDCH monitoring occasions corresponding to one or more SSBs transmitted in the cell.

19. The electronic device of claim 14, wherein the SSB associated with the RACH preamble transmission for requesting the SIB1 of the cell is:
an SSB amongst SSBs transmitted in the cell with a synchronization signal-reference signal received power (SS-RSRP) above a configured threshold; or
in circumstances where there is no SSB amongst the SSBs transmitted in the cell with an SS-RRSP above the configured threshold, any SSB amongst the SSBs transmitted in the cell.

20. The electronic device of claim 14, wherein:
the instructions, when executed by the at least one processor individually or collectively, further cause the electronic device to receive a random access response (RAR) corresponding to the RACH preamble transmission for requesting the SIB1 of the cell; and
the electronic device begins the PDCCH monitoring in response to the first determination being affirmative after receiving the RAR.
